(19) United States
(12) Patent Application Publication
(10) Pub. No.: US 2004/0228143 A1
(43) Pub. Date: Nov. 18, 2004

(54) Transparent rod with optical fiber core

(76) Inventor: John B. Squicciarini, Aliso Viejo, CA (US)

Correspondence Address: ROBERT D. FISH, RUTAN & TUCKER LLP, 611 ANTON BLVD 14TH FLOOR, COSTA MESA, CA, 92626-1931, US

(21) Appl. No.: 10/845,725

(22) Filed: May 14, 2004

Related U.S. Application Data
(60) Provisional application No. 60/471,128, filed on May 16, 2003.

(51) Int. Cl. F21V 8/00

(52) U.S. Cl. 362/555

(57) ABSTRACT

An apparatus having a side emitting fiber encased in a translucent or transparent rod such as a towel rack, curtain rod, or toilet paper dispenser.

This application claims priority to U.S. application Ser. No. 60/471128, filed May 16, 2003, which is incorporated herein by reference in its entirety.

### FIELD OF THE INVENTION

The field of the invention is remote source lighting.

### BACKGROUND OF THE INVENTION

Remote source lighting systems and methods such as the use of fiber optic and/or prism guides to transmit light are known and provide numerous advantages over more traditional lighting systems and methods. However, known remote source lighting apparatus and methods can still be improved to better achieve such advantages. As such, there is a continuing need for improvements to remote source lighting apparatus and methods.

### SUMMARY OF THE INVENTION

The present invention is directed to transparent or translucent rod assemblies comprising one or more optical fiber cores and possibly one or more illuminators, as well as methods for making and using such assemblies. For simplicity, the invention will be described using the term “transparent” in place of “transparent or translucent”.

In some instances rod assemblies comprising a transparent rod with a optical fiber core will be formed by providing a hollow-core rod and using the rod as a mold to create in creating an optical fiber core for the assembly.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1A is a perspective view of a transparent rod assembly comprising an RLS.

FIG. 1B is a perspective view of the RLS of FIG. 1A.

FIG. 2A is a view of a towel rack comprising an RLS rod assembly.

FIG. 2B is a detail view of a bracket portion of the assembly of FIG. 2A.

### DETAILED DESCRIPTION

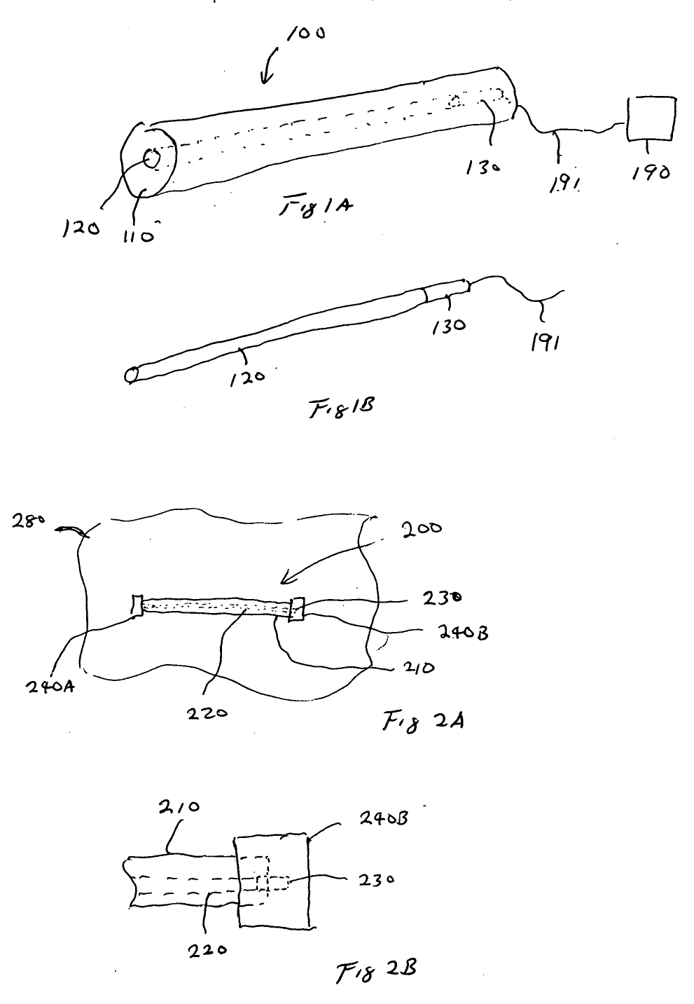

In FIG. 1A a transparent rod assembly 100 comprising an RLS is shown. Assembly 100 comprises a transparent rod 110, an optical fiber core 120, an illuminator 130, one or more conductors 191, and a power source 190. The RLS of assembly 100 is shown removed from the encapsulating rod in FIG. 1B. As previously mentioned, the “transparent” rod can be transparent or translucent. Assembly 100 may part of a towel rack, a toilet paper dispenser, or any other apparatus that would benefit from the inclusion of a transparent rod assembly comprising an RLS.

Rod 110 may comprise any transparent or translucent material or any combination of materials so long as at least some of the light emitted by core 120 will be emitted by rod 110. In some instances 110 may be structured such that light emitted by core 120 is patterned, color shifted, or otherwise modified prior to being emitted by rod 110.

Core 120 may comprise a single optical fiber, a plurality of optical fibers, or some other form of optical wave guide. In less preferred embodiments core 120 may remain hollow except possibly where it is coupled to an illuminator. In some embodiments the core may comprise a gas that facilitates the transmission of light along core 120 and which may modify the light as it is transmitted. Core 120 may be formed by providing a hollow rod 110 and filling rod 110 with an appropriate material. In such instances rod 110 may act as a mold used to shape core 120. Core 120 may comprise any material or combination of materials suitable for transmitting light along the length of rod 110.

Illuminator 130 may be any illuminator suitable for transmitting light into core 120 such that it is emitted by rod 110. However, it is preferred that illuminator 130 comprise an LED illuminator. In some instances illuminator 130 may comprise a cluster LED such as an RGB cluster LED. Illuminator 130 may also comprise one or more control circuits used to control the illuminator. Illuminator 130 is shown positioned within rod 110 but in alternative embodiments illuminator 130 may be positioned outside of rod 110, possibly by extending core 120 out of rod 110 prior to coupling an end of the core to the illuminator.

Power source 190 may be an external power source such as a socket coupled to electrical utility power source or may be an internal power source such as a battery or capacitor. If an external power source, one or more conductors 191 may be used to provide power and possibly control signals to illuminator 130.

Assembly 100 may comprise one or more control circuits adapted to facilitate the selection of the color and/or intensity of light to be emitted by assembly 100.

In FIGS. 2A and 2B a transparent rod assembly in the form of a towel rack is shown mounted on wall 280 and comprises rod 210, core 220, illuminator 230, and end brackets 240A and 240B. As can be seen in FIG. 2B, illuminator 230 is positioned within bracket 240B. Assembly 200 also comprises a power source (not shown).

The variations described in regard to assembly 100 of FIG. 1A are equally applicable to assembly 200. The primary difference between the two assemblies 100 and 200 is the inclusion of end brackets in 200 and the position of the illuminator 230 at least partially outside of rod 210.

It is contemplated that it may be particularly advantageous for the power source for the assembly 100 to comprise one or more batteries and/or capacitors positioned within the assembly or an external power source. If an external power source, it is preferred that power be routed into the assembly through bracket 240B with any conductors and or plugs being hidden by bracket 240B and/or wall 280.

Alternative embodiments may comprise a plurality of cores, illuminators, controllers, and/or power sources in any combination.

Thus, specific embodiments, applications, and methods relating to remote source lighting systems have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. An apparatus comprising a side emitting fiber encased in a translucent or transparent rod.

2. The apparatus of claim 1 wherein the rod is a shower curtain rod.

3. An optical fiber formed by filling a transparent or translucent mold with a liquid and allowing the liquid to harden into a transparent or translucent solid.

4. An apparatus comprising a transparent or translucent rod and an RLS at least partially embedded within the transparent or translucent rod.

5. The apparatus of claim 4 wherein the RLS comprises an LED illuminator.

6. The apparatus of claim 5 wherein the LED illuminator is a cluster LED.

7. The apparatus of claim 6 wherein the cluster LED is an RGB LED.

8. The apparatus of claim 5 wherein the RLS comprises at least two separate LED illuminators.

9. The apparatus of claim 5 wherein the RLS further comprises a mechanism adapted to facilitate the selection of a color to be emitted by the RLS.

10. The apparatus of claim 9 further comprising at least one bracket adapted to couple the apparatus to a surface and a plug adapted to plug into a socket positioned in the surface wherein when coupled to the surface the socket and plug will be hidden by the bracket.

11. The apparatus of claim 10 wherein the socket is electrically coupled to a power source in a manner that allows power provided to the socket by the power source to be switched on and off via a wall switch.

12. The apparatus of claim 5 further comprising one or more batteries and/or capacitors electrically coupled to the illuminator.
